(19) United States
(12) Patent Application Publication
(10) Pub. No.: US 2013/0014354 A1
(43) Pub. Date: Jan. 17, 2013

(54) SEAT BELT COMFORT ENHANCING DEVICE

(71) Applicant: GENE ARTHUR ROBBINS, LELAND, NC (US)

(72) Inventor: GENE ARTHUR ROBBINS, LELAND, NC (US)

(73) Assignee: NO CHOKE, LLC, LELAND, NC (US)

(21) Appl. No.: 13/350,675

(22) Filed: Jan. 13, 2012

Related U.S. Application Data
(60) Provisional application No. 61/432,989, filed on Jan. 14, 2011.

(51) Int. Cl. B60R 21/02

(52) U.S. Cl. 24/302

(57) ABSTRACT

An apparatus for altering the positioning of a seat belt shoulder strap relative to a user is presented. More specifically, an apparatus is presented whereby alteration of the positioning of a seat belt shoulder strap relative to a user is engendered via direct interaction between an intermediate point of the shoulder strap and a body part of the user. The now disclosed invention seeks to remediate the problem of discomfort caused by the positioning of a seatbelt shoulder strap in relation to a user through the use of an apparatus that alters the positioning of the shoulder strap in relation to a user by force generated through the interaction of the user's body with a means of restraining the shoulder strap.

### CROSS-REFERENCE TO RELATED APPLICATIONS

This application claims the benefit of U.S. Provisional Application Ser. No. 61/432,989 filed Jan. 14, 2011, which is hereby incorporated by reference in its entirety.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

The present invention relates generally to an apparatus for use with the shoulder strap component of a seat belt of the type commonly found in a vehicle. More specifically, the present invention relates to an apparatus intended for utilization to improve the comfort of the shoulder strap component of a seat belt in relation to a user when the seat belt is in use.

Seat belts and other vehicular seat restraint systems commonly feature a mechanical design wherein a user is restrained in a seated position by a combination of a waist strap component and a shoulder strap component. Although the inventor acknowledges that discomfort with regard to the use of a seat belt can be attributed to either or both the waist strap component and the shoulder strap component, discomfort occasioned by a waist strap component is beyond the purview of the present disclosure and, in fact, it is the intent and focus of the inventor to provide an effective means of remediating discomfort occasioned by a shoulder strap component.

2. Background Art

Seat belts and other vehicular seat restraint systems commonly feature a standard arrangement featuring a waist or lap strap to secure a user's lower torso and a shoulder strap designed to secure the user's upper torso. In nearly all embodiments of the common seat belt, the waist strap component of the arrangement is adjustable and allows persons of differing sizes to adjust the waist strap to their respective likings regardless of body size and shape. Unlike the waist strap, the the shoulder strap component of the arrangement is rarely adjustable and is commonly an awkward and uncomfortable nuisance for children, smaller individuals, well-endowed women, and other persons for whom the proximity of the shoulder strap to their face and neck provides substantial discomfort. The discomfort caused to a person by the use of a shoulder strap may force the individual to forego the use of the seat belt or vehicular restraint system altogether, thus increasing the risk of injury or death to the individual in the event of a collision.

As identified above, the present arrangement of the shoulder strap component of a common seat belt assembly can cause substantial discomfort to a user and ultimately encourages the forbearance of seat belt use and, thus, the concomitant negative public policy result of decreased highway safety. In light of the aforementioned circumstances, there is and has been a long-standing need for an apparatus that can enhance the level of comfort experienced by a passenger using a seat belt assembly featuring a shoulder strap component. Several inventions have attempted to meet this long standing need.

U.S. Pat. No. 5,421,614 to Yu Zheng discloses a seat belt adjuster adapted to receive a conventional seat belt and alter the positioning of a shoulder strap in relation to a user. The mechanism whereby the invention accomplishes this result is by tethering the shoulder strap to the waist strap by enclosing both between two panels and creating channels between the two panels through the use of Velcro straps adjusted per a user's preferences.

U.S. Pat. No. 4,799,737 to Marc B. Greene discloses a device for adjusting the shoulder strap of a vehicular seat restraint system to allow for passengers of varying heights by engaging the shoulder strap at a point intermediate to its upper and lower ends of attachment within the seat belt assembly and providing a third point of attachment for the shoulder belt to the vehicle.

U.S. Pat. No. 4,938,535 to Dolores Condon, et al. discloses a fully adjustable shoulder/lap seat belt adapter for maintaining correct placement and spacing per a user's selection between the shoulder strap and and lap strap of an existing seat belt assembly. As with Zheng, the mechanism whereby this invention operates is a direct attachment of the shoulder strap to the waist strap.

U.S. Pat. No. 4,958,416 to Dan Frishling discloses an invention very similar to that disclosed by Condon wherein Frishling conceives the maintenance of correct placement and spacing as between shoulder strap and lap strap via an adapter that clips at each end of the adapter, one end to an intermediate point in the shoulder strap and the second end to an intermediate point in the waist strap.

U.S. Pat. No. 5,201,099 to Terry A. Campbell discloses an adapter that adjusts the placement of a shoulder strap in a three-point seat belt assembly by means of a clipping mechanism that tethers a shoulder strap directly to the waist strap at a single point where the adapter clip is engaged.

U.S. Pat. No. 6,203,110 to Judy P. Proteau, et al. discloses a seat belt adjuster similar to that disclosed by Campbell wherein the seat belt adjuster tethers a shoulder strap directly to the waist strap at a single point where the seat belt adjuster is engaged. The specific mechanism of operation differs in that the Proteau disclosure operates by means of a dual cuff, one cuff enveloping the shoulder strap and the second cuff enveloping the waist strap.

U.S. Patent Application 2003/0172500 filed by William Reilly discloses a shoulder strap re-positioner wherein a clip having an “S” configuration is positioned in such a way as to tether the shoulder strap directly to the waist strap of a standard three-point seat belt assembly, the shoulder strap being engaged by the upper open loop and the waist strap being engaged by the lower open loop of the “S” configured clip mechanism.

U.S. Pat. No. 6,142,575 to Kimberly A. Patterson discloses a safety belt adjuster similar to Zheng wherein a larger body of material engages both the waist strap and shoulder strap, altering the trajectory and positioning of the shoulder strap by the influence of openings and slots within the body of material.

U.S. Pat. No. 5,605,380 to Paul J. Gerstenberger, et al. discloses a seat belt adjuster, again designed to alter the positioning of a shoulder strap in relation to a user, wherein the mechanism by which the adjuster alters the positioning of the shoulder strap is a means of connecting the shoulder strap to the lap strap in such a way that the two remain at a fixed distance from one another and the shoulder strap remains away from the face and neck of a user.

U.S. Pat. No. 4,786,078 to Steven E. Schreier discloses yet another seat belt adjuster that operates by clipping the shoulder strap to the waist strap, thereby altering the trajectory and positioning of the shoulder strap as the same proceeds upward across the torso of a user.

As can be appreciated from the above cited prior art examples, the state of the art favors adjustment of the positioning of a shoulder strap of a standard three-point seat belt assembly in relation to a user by varying means in which the shoulder strap is tethered directly to the waist or lap strap of the seat belt assembly. Adjustment of the shoulder strap in this manner creates additional strains on both the shoulder strap and the waist strap of the seat belt assembly and affects the dispersion of forces in the seat belt in the event of a collision. Further, adjustment of the shoulder strap in this manner is only effective if the user does not change position beneath the re-positioned shoulder strap.

Beyond the cited prior art, various inventors have disclosed mechanisms whereby the shoulder strap of a seat belt assembly in a vehicle may be altered by means of direct attachment of an intermediate point in the shoulder strap directly to a component of the vehicle interior or chassis, such as a door frame or interior wall. Although likely effective, adjustment of the shoulder strap in this manner requires modification of the vehicle or the manufacturer's installation of the mechanism at the time the car is assembled. Accordingly, adjustment of the shoulder strap by this means is both costly and static.

It is further known in the prior art that mechanisms may be attached to the shoulder strap that regulate the amount of slack that a user chooses to keep in an engaged seat belt shoulder strap. To the extent that a user selects to maintain a level of slack in the shoulder strap sufficient to reposition the shoulder strap away from the face and neck of the user, it seems clear that the effectiveness of the seat belt assembly in the event of an accident is compromised and, therefore, this method is not favored.

### BRIEF SUMMARY OF THE INVENTION

Broadly stated, an apparatus for altering the positioning of a seat belt shoulder strap relative to a user is presented. More specifically, an apparatus is presented whereby alteration of the positioning of a seat belt shoulder strap relative to a user is engendered via direct interaction between an intermediate point of the shoulder strap and a body part of the user. In this sense, the now disclosed inventive concept is not dependent upon interaction of any kind with the waist strap of a seat belt assembly nor direct interaction with any other interior component of the vehicle in which the seat belt assembly is installed.

In more specific embodiment, the present invention is an apparatus for altering the positioning of a seat belt shoulder strap relative to a user by means of restraint, wherein the means of restraint exerts force upon the shoulder strap at a point intermediate to the total length of the shoulder strap when the means of restraint is in interaction with a body part of the user, the body part preferably being the arm of the user.

It is an object of the present invention to provide a mechanism whereby a seat belt assembly shoulder strap may be repositioned in relation to a user by means of restraint rendered operative via interaction with a body part of the user, the body part preferably being an arm, thus enabling an adjusted shoulder strap position that is dynamic as opposed to static, the present invention enabling the position of the shoulder strap to be constantly altered in relation to the user based upon the user's own movements.

It is yet another object of the present invention to provide a mechanism whereby a seat belt assembly shoulder strap may be repositioned in relation to a user by use of an apparatus that is both easy to use and inexpensive to manufacture and implement.

It is still yet another object of the present invention to provide a mechanism whereby a seat belt assembly shoulder strap may be repositioned in relation to a user by use of an apparatus that may be adjusted for a user's preferences a single time and thereafter be constantly ready for implementation without further modification by a user.

It is an even further object of the present invention to promote a higher incidence of seat belt usage among motorists by alleviating the discomforts of an ill-positioned seat belt assembly shoulder strap.

These and other advantages of the present disclosed apparatus will become apparent to one skilled in the art in view of the figures and descriptions of the figures stated below.

### BRIEF DESCRIPTION OF THE SEVERAL VIEWS OF THE DRAWING

The aforementioned advantages of the invention, as well as additional advantages thereof will be more fully understood as a result of a detailed description of the preferred embodiment when taken in conjunction with the accompanying drawings in which:

FIG. 1 is a perspective view of the preferred embodiment of the disclosed apparatus in a disengaged and open orientation.

FIG. 2 is a perspective view, this being an overhead view, of the preferred embodiment of the disclosed apparatus.

FIG. 3 is a perspective view of the preferred embodiment of the disclosed apparatus in use by a user, engaged and in closed orientation.

### DETAILED DESCRIPTION OF THE INVENTION

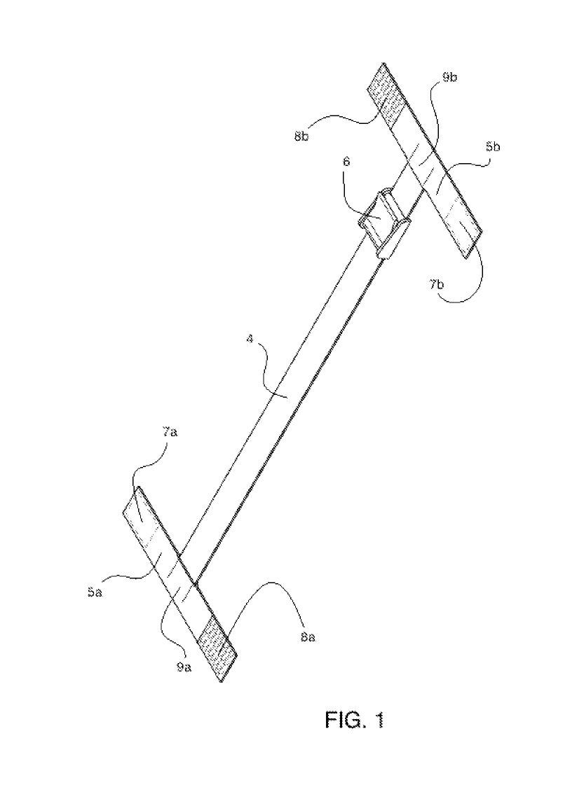

Referring first to FIG. 1, there is shown a perspective view of the preferred embodiment of the disclosed apparatus in a disengaged and open orientation. Specifically, FIG. 1 shows the inventive concept in is preferred embodiment or best mode as determined by the inventor, said embodiment comprising a length of material 4, preferably an elastic strapping, having a first terminus 9a and a second terminus 9b, each terminus designed to be attached to a point in a seat belt system shoulder strap intermediate in location to the upper and lower ends of the shoulder strap. Specifically, FIG. 1 shows a first cuffing mechanism 5a at the first terminus 9a of the length of material 4, the first cuffing mechanism 5a being here demonstrated in the disengaged and open orientation, having the capacity for engagement and closure for attachment to a seat belt system shoulder strap by a hook-and-loop closure comprising a series of loops 8a that interact with a series of hooks 7a when the first cuffing mechanism 5a is engaged, thus facilitating a durable closure and attachment of the first terminus 9a of the length of material 4 to a seat belt system shoulder strap. Likewise, FIG. 1 further shows a second cuffing mechanism 5b at the second terminus 9b of the length of material 4, the second cuffing mechanism 5b being again demonstrated in the disengaged and open orientation, having the capacity for engagement and closure for attachment to a seat belt system shoulder strap by a hook-and-loop closure comprising a series of loops 8b that interact with a series of hooks 7b when the first cuffing mechanism 5b is engaged, thus facilitating a durable closure and attachment of the second terminus 9b of the length of material 4 to a seat belt system shoulder strap. Further depicted in FIG. 1 is the adjustable nature of the length of material 4, the length of material 4 being preferably constructed of an elastic strapping and, as depicted in FIG. 1, adjustable in length by means of a cam buckle 6 operative to extend or contract the length of material 4 through either the interaction of two lengths of material joined by the cam buckle 6 or by means of the single length of material 4 doubling back on itself as regulated by the cam buckle 6.

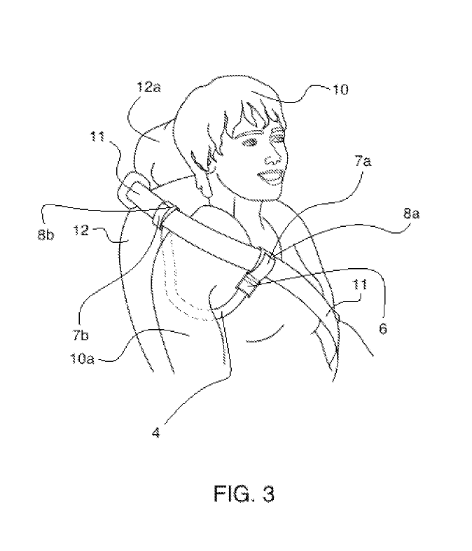

Referring now to FIG. 3, there is shown a perspective view of the preferred embodiment of the disclosed apparatus in use by a user 10, engaged and in closed orientation. Again, FIG. 3 shows the inventive concept in its preferred embodiment or best mode as determined by the inventor, said embodiment comprising a length of material 4, preferably an elastic strapping, having a two ends, each end equipped with means to attach to a point in a seat belt system shoulder strap 11 intermediate in location to the upper and lower ends of the shoulder strap 11. Specifically, FIG. 3 shows one end of the length of material 4 attached to an upper point on the seat belt shoulder strap 11 by means of a hook-and-loop closure engaged via the interaction of a series of loops 8b with a series of hooks 7b. From this end attached to an upper point of the seat belt shoulder strap 11, the length of material 4, in use, passes beneath the arm 10a of a user 10 to a second end of the length of material 4 attached to a lower point of the seat belt shoulder strap 11 by means of a hook-and-loop closure engaged via the interaction of a series of loops 8a with a series of hooks 7a. Again depicted in FIG. 3 is the adjustable nature of the length of material 4, the length of material 4 being preferably constructed of an elastic strapping and, as depicted in FIG. 1 and FIG. 3, adjustable in length by means of a cam buckle 6 operative to extend or contract the length of material 4 through either the interaction of two lengths of material joined by the cam buckle 6 or by means of the single length of material 4 doubling back on itself as regulated by the cam buckle 6.

Further depicted in FIG. 3 is the actual relationship between the apparatus, the user 10, and the seat belt system shoulder strap 11. One of ordinary skill in the art will appreciate that the placing of the length of material 4 beneath the arm 10a of the user 10 causes the length of material 4 to exert a downward pulling force upon the seal belt shoulder strap 11 at each of the two points along the shoulder strap 11 whereat the length of material 4 attaches to the shoulder strap 11, thus restraining the shoulder strap 11 from its expected and typical proximity to the neck and face of the user 10. As depicted in FIG. 3, one of ordinary skill in the art will further appreciate that the restraint of the shoulder strap 11 by means of the length of material 4 running beneath the arm 10a of a user 10 further enables the user 10 to maintain the useful and effective restraint of the shoulder strap 11 from the face and neck area of the user 10 without regard to movement by the user 10 within the seat 12 or movement of the head of a user 10 upon the seat headrest 12a. Further, varying degrees of restraint of the seat belt shoulder strap 11 may be achieved by varying user 10 selections in adjusting the length of material 4 by use of the provided cam buckle 6, a shorter length of material 4 equating to a higher degree of restraint and a longer length of material 4 equating to a lesser degree of restraint.

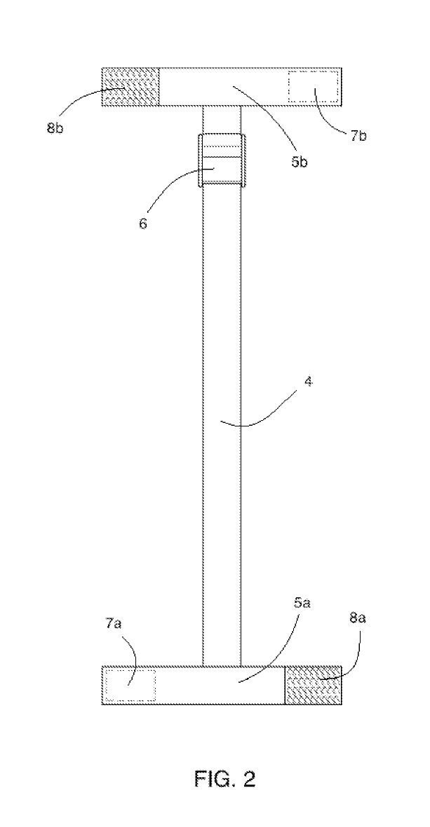

Referring now to FIG. 2, there is shown a perspective view, this being an overhead view, of the preferred embodiment of the disclosed apparatus, the view intended to further disclose in more detail the cuffing mechanism located at each end of the length of material 4. FIG. 2 in further detail depicts a first cuffing mechanism 5a at an end of the length of material 4, the first cuffing mechanism 5a being here demonstrated, again, in the disengaged and open orientation, having the capacity for engagement and closure for attachment to a seat belt system shoulder strap by a hook-and-loop closure comprising a series of loops 8a that interact with a series of hooks 7a when the first cuffing mechanism 5a is engaged, thus facilitating a durable closure and attachment of the associated end of the length of material 4 to a seat belt system shoulder strap. Further demonstrated in FIG. 2 is the adjustable cam buckle 6 from an overhead view perspective.

While the foregoing written description of the disclosed invention enables one of ordinary skill to practice and use what is considered presently to be the best mode thereof, those of ordinary skill will understand and appreciate the existence of variations, combinations, and equivalents of the specific embodiment, method and examples herein. The invention should therefore not be limited by the above described embodiment, method and examples, but by all embodiments and methods within the scope and spirit of the invention as claimed.

Further, while specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. An apparatus for altering the positioning of a seat belt shoulder strap relative to a user, the apparatus comprising means of restraining the shoulder strap, the means altering the position of the shoulder strap relative to a user when the means is in interaction with the arm of the user.

2. The apparatus of claim 1 wherein the means of restraining the shoulder strap is a length of material attached to the seat belt shoulder strap at each terminus of the length of material, the attachment resulting in a closed loop formed between the length of material and the shoulder strap;

3. The apparatus of claim 2 wherein the length of material restrains the shoulder strap by way of interaction of the arm of a user with the closed loop formed between the length of material and the shoulder strap;

4. The apparatus of claim 3 wherein the length of material is adjustable in length;

5. The apparatus of claim 4 wherein the length of material is comprised of at least one elastic strap;

6. The apparatus of claim 4 wherein the length of material is adjustable by means of a cam buckle;

7. The apparatus of claim 2 wherein attachment of the length of material to the shoulder strap is by fastener means;

8. The apparatus of claim 7 wherein the fastener means is a hook-and-loop type closure;

9. The apparatus of claim 7 wherein the length of material restrains the shoulder strap by way of interaction of the arm of a user with the closed loop formed between the length of material and the shoulder strap;

10. The apparatus of claim 9 wherein the length of material is adjustable in length;

11. The apparatus of claim 10 wherein the length of material is comprised of at least one elastic strap;

12. The apparatus of claim 10 wherein the length of material is adjustable by means of a cam buckle.

13. The apparatus of claim 8 wherein the length of material restrains the shoulder strap by way of interaction of the arm of a user with the closed loop formed between the length of material and the shoulder strap;

14. The apparatus of claim 13 wherein the length of material is adjustable in length;

15. The apparatus of claim 14 wherein the length of material is comprised of at least one elastic strap;

16. The apparatus of claim 14 wherein the length of material is adjustable by means of a cam buckle.
